(19) United States
(12) Patent Application Publication
(10) Pub. No.: US 2026/0284964 A1
(43) Pub. Date: Sep. 24, 2026

(54) METHODS AND APPARATUS FOR ROLLING FILM ADDITIVE MANUFACTURING USING LIGHT SCATTERING FILM

(71) Applicant: Carbon, Inc., Redwood City, CA (US)

(72) Inventor: Bernard Carreon, Berkeley, CA (US)

(21) Appl. No.: 19/563,309

(22) Filed: Mar. 11, 2026

Related U.S. Application Data
(60) Provisional application No. 63/773,948, filed on Mar. 18, 2025.

(51) Int. Cl. B29C 64/124; B29C 64/245; B29C 64/295; B33Y 10/00; B33Y 30/00

(52) U.S. Cl. CPC B29C 64/124; B29C 64/245; B29C 64/295; B29K 2995/0026; B33Y 10/00; B33Y 30/00

(57) ABSTRACT

An apparatus for forming a three-dimensional object includes: (a) at least one radiation source; (b) a build platform on which a three-dimensional object is formed; (c) an optically transparent film and a film transport assembly for moving the optically transparent film between the at least one radiation source and the build platform; (d) an applicator for coating polymerizable material onto the optically transparent film; (e) at least one controller and/or drive assembly; and (f) optionally a housing and/or frame, wherein the optically transparent film (i) comprises light scattering particles therein and/or thereon; and/or (ii) has an optical profile that varies along the length, and optionally the width, of the film.

### REFERENCE TO PRIORITY APPLICATION

The present application claims priority from U.S. Provisional Patent Application No. 63/773,948, filed on March 18, 2025, the disclosure of which is incorporated by reference in its entirety.

### FIELD OF THE INVENTION

The present invention relates to apparatus and methods for additive manufacturing, and in particular, apparatus and methods for rolling film additive manufacturing.

### BACKGROUND

A group of additive manufacturing techniques sometimes referred to as “stereolithography” create a three-dimensional object by the sequential polymerization of a light polymerizable resin. Such techniques may be “bottom-up” techniques, where light is projected into the resin onto the bottom of the growing object through a light transmissive window, or “top down” techniques, where light is projected onto the resin on top of the growing object, which is then immersed downward into a pool of resin.

The introduction of a rapid stereolithography technique sometimes referred to as continuous liquid interface production (CLIP) has expanded the usefulness of stereolithography from prototyping to manufacturing. See e.g., J. Tumbleston, et al., Continuous liquid interface production of 3D objects, Science, 347, 1349-1352; R. Janusziewicz, et al., Layerless fabrication with continuous liquid interface production, PNAS, 113, 11703-11708 (18 October 2016); and U.S. Pat. Nos. 9,211,678, 9,205,601, and 9,216,546.

Rolling film printing (also referred to as “RFP”) additive manufacturing methods are known in the art. For example, apparatus and methods for RFP are described in U.S. Patent Nos. 10,792,868, 11,654,625, and 11,376,787, and in PCT Publication No. WO2024/197214, the contents of each of which are herein incorporated by reference in their entirety. However, new methods and apparatus for additive manufacturing may be useful to provide improved properties in the produced three-dimensional objects.

### SUMMARY

Some embodiments of the present invention are directed to a method of making a three-dimensional object, including: (a) coating polymerizable material onto an optically transparent film; (b) positioning a first portion of the film having polymerizable material thereon between a radiation source and a build platform such that the polymerizable material contacts the build platform; (c) irradiating the polymerizable material through the first portion of the film with the radiation source to solidify and laminate the polymerizable material onto the build platform, thereby forming an object (e.g., object layer) attached to the build platform; (d) positioning an additional portion of the film having additional polymerizable material thereon between the radiation source and the build platform such that the additional polymerizable material contacts the object; (e) irradiating the additional polymerizable material through the additional portion of the film (e.g., in a predetermined pattern) with the radiation source to solidify and laminate the additional polymerizable material onto the object, thereby adding a layer to the object; (f) repeating steps (d) and (e) until the object attached to the build platform forms the three-dimensional object or an intermediate having the same shape, or the shape to be imparted to, the three-dimensional object, wherein: (i) each portion of the optically transparent film has an optical profile and at least one portion of the film that is irradiated in step (c) or step (e) has a different optical profile from at least one other portion of the film irradiated in step (c) or step (e); and/or (ii) the optically transparent film includes scattering particles dispersed therein.

In some embodiments, the optical profile of the optically transparent film varies along the length, and optionally the width, of the film.

In some embodiments, the transmittance of at least one portion of the film that is irradiated in step (c) or step (e) is different than the transmittance of the at least one other portion of film irradiated in step (c) or step (e).

In some embodiments, the optical profile of the film is varied by varying the amount of scattering particles in the film.

In some embodiments, the scattering particles include one or more of transparent to semi-transparent microspheres (e.g., aluminoscilates, borosilicates, polystyrene and/or polypropylene).

In some embodiments, the scattering particles have a diameter or longest width in a range of 1 𝜇m to 100 𝜇m (e.g., 2 𝜇m to 12 𝜇m).

In some embodiments, the scattering particles are present in the film at a concentration in a range of 2 weight percent to 50 weight percent.

In some embodiments, the intermediate having the same shape, or the shape to be imparted to, the three-dimensional object is formed, and the method further includes further curing the intermediate to form the three-dimensional object.

In some embodiments, further curing includes heating, microwave irradiation, and/or contacting the intermediate with water.

In some embodiments, during irradiation, a dead zone of unpolymerized material is present between (i) the polymerizable material and the first portion of optically transparent film and (ii) the additional polymerizable material and the additional portion of portion of the optically transparent film.

Some other embodiments of the present invention are directed to an apparatus for forming a three-dimensional object, including: (a) at least one radiation source; (b) a build platform on which a three-dimensional object is formed; (c) an optically transparent film and a film transport assembly for moving the optically transparent film between the at least one radiation source and the build platform; (d) an applicator for coating polymerizable material onto the optically transparent film; (e) at least one controller and/or drive assembly; and (f) optionally a housing and/or frame, wherein the optically transparent film (i) includes light scattering particles therein and/or thereon; and/or (ii) has an optical profile that varies along the length, and optionally the width, of the film.

In some embodiments, the optical profile of the film varies along the length, and optionally the width, of the film.

In some embodiments, the optical profile of the film varies by varying the amount of scattering particles in the film.

In some embodiments, the scattering particles include one or more of transparent to semi-transparent microspheres (e.g., aluminoscilates, borosilicates, polystyrene and/or polypropylene).

In some embodiments, the scattering particles have a diameter or longest width in a range of 1 𝜇m to 100 𝜇m (e.g., 2 𝜇m to 12 𝜇m).

In some embodiments, the scattering particles are present in the film at a concentration in a range of 2 weight percent to 50 weight percent.

In some embodiments, the apparatus is configured to perform a method of the invention.

Some other embodiments of the present invention are directed to an object formed by a method and/or apparatus of the invention.

### BRIEF DESCRIPTION OF THE FIGURES

FIG. 1 is a schematic of a rolling film apparatus used in embodiments of the invention.

FIG. 2 is a flow chart illustrating the steps of a rolling film printing method according to embodiments of the invention.

FIG. 3A is an illustration of a length of optically transparent film showing how the optical profile of the film may vary along the length of the film according to some embodiments of the invention.

FIG. 3B is an illustration of a length of optically transparent film showing how the optical profile of the film may vary along the length of the film according to some embodiments of the invention.

FIG. 3C is an illustration of a length of optically transparent film showing how the optical profile of the film may vary along the length of the film according to some embodiments of the invention.

FIG. 4 is a diagram of a user interface and controller that may be used in some embodiments of the invention.

### DETAILED DESCRIPTION OF CERTAIN EMBODIMENTS OF THE INVENTION

In the following discussion that addresses several embodiments and applications of the present invention, reference is made to the accompanying drawings that form a part thereof, where depictions are made, by way of illustration, of specific embodiments in which the invention may be practiced. It is to be understood that other embodiments may be utilized, and changes may be made without departing from the scope of the invention.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements components and/or groups or combinations thereof, but do not preclude the presence or addition of one or more other features, integers, steps, operations, elements, components and/or groups or combinations thereof.

As used herein, the term “and/or” includes any and all possible combinations or one or more of the associated listed items, as well as the lack of combinations when interpreted in the alternative (“or”).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and claims and should not be interpreted in an idealized or overly formal sense unless expressly so defined herein. Well-known functions or constructions may not be described in detail for brevity and/or clarity.

It will be understood that when an element is referred to as being “on,” “attached” to, “connected” to, “coupled” with, “contacting,” etc., another element, it can be directly on, attached to, connected to, coupled with and/or contacting the other element or intervening elements can also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature can have portions that overlap or underlie the adjacent feature.

Spatially relative terms, such as “under,” “below,” “lower,” “over,” “upper” and the like, may be used herein for ease of description to describe an element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus the exemplary term “under” can encompass both an orientation of over and under. The device may otherwise be oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only, unless specifically indicated otherwise.

It will be understood that, although the terms first, second, etc., may be used herein to describe various elements, components, regions, layers and/or sections, these elements, components, regions, layers and/or sections should not be limited by these terms. Rather, these terms are only used to distinguish one element, component, region, layer and/or section, from another element, component, region, layer and/or section. Thus, a first element, component, region, layer or section discussed herein could be termed a second element, component, region, layer or section without departing from the teachings of the present invention. The sequence of operations (or steps) is not limited to the order presented in the claims or figures unless specifically indicated otherwise.

All patents or published patent applications referenced are herein incorporated by reference in their entirety. In the case of conflicting terminology, the present application controls.

It is noted that aspects or features of the devices described with respect to one embodiment, may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail in the specification set forth below.

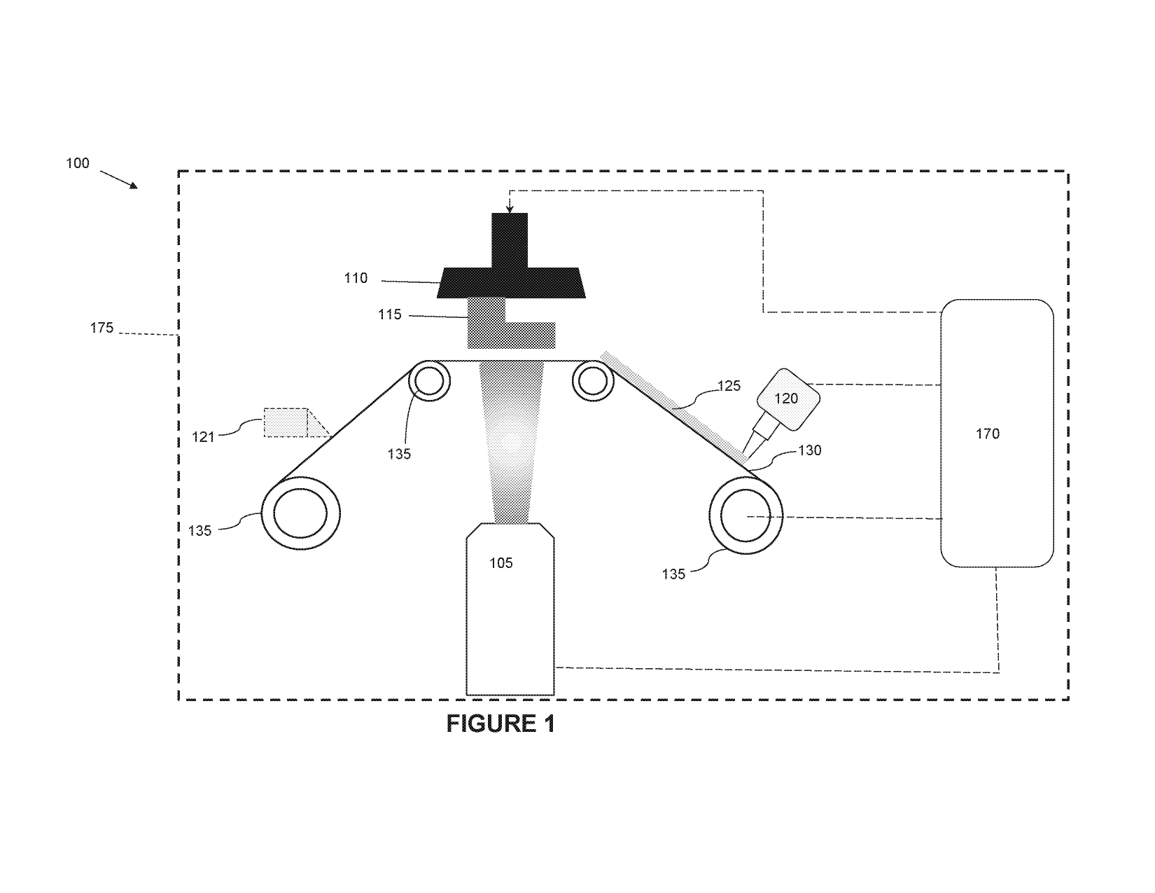

Provided according to embodiments of the invention are apparatus that (i) include light scattering particles therein and/or thereon; and/or (ii) have an optical profile that varies along the length, and optionally the width, of the film. For example, referring to FIG. 1, a RFP apparatus 100 may include (a) a radiation source 105; (b) a build platform 110 on which a three-dimensional object 115 is formed; (c) an applicator 120 for coating polymerizable material 125 onto an optically transparent film 130; (d) a film transport assembly 135 for moving the optically transparent film between a radiation source assembly 105 and the build platform 110; (e) at least one controller and/or drive assembly 170 to energize and/or control the apparatus 100 or one or more parts thereof, including the radiation source 105, the build platform 110, the coating applicator 120, and/or the film transport assembly 135; and (f) optionally, a housing and/or frame 175 that connects and/or supports one or more of the apparatus, wherein the optically transparent film 130 (i) comprises light scattering particles therein and/or thereon; and/or (ii) has an optical profile that varies along the length, and optionally the width, of the film 130. The apparatus 100 may optionally further include a resin removal device 121 to remove the excess polymerizable material 125 remaining on the film 130.

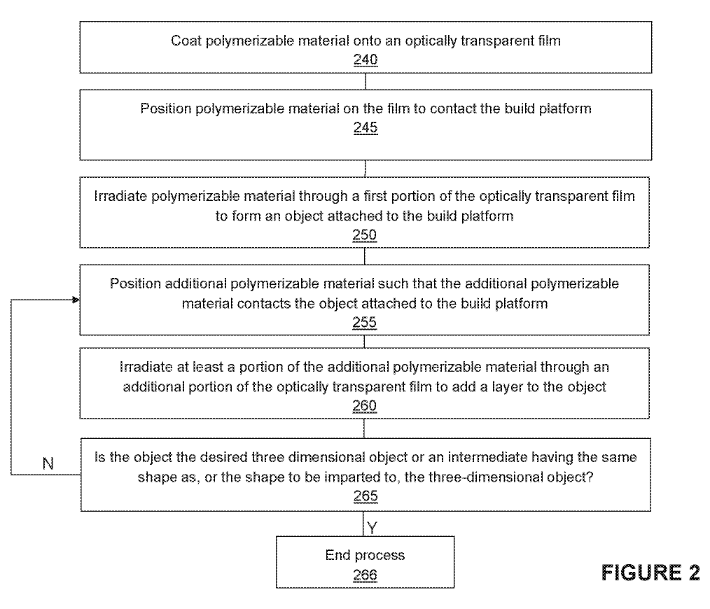

In addition, also provided are RFP methods that use an optically transparent film that (i) includes light scattering particles therein and/or thereon; and/or (ii) has an optical profile that varies along the length, and optionally the width, of the film. An example method is described in the block diagram in FIG. 2. Referring to step 240, a polymerizable material may be coated onto an optically transparent film. Referring to step 245, polymerizable material on the film may then be positioned between a radiation source and a build platform such that polymerizable material contacts the build platform. Referring to step 250, a portion of the polymerizable material may then be irradiated through a first portion of optically transparent film with the radiation source to solidify and laminate the polymerizable material to the build platform to form an object (e.g., an object layer) attached to the build platform. Referring to step 255, additional polymerizable material may then be positioned between the radiation source and the build platform such that the additional polymerizable material contacts the object attached to the build platform. Referring to step 260, at least a portion of the additional polymerizable material may then be irradiated through an additional (or second) portion of optically transparent film with the radiation source to solidify and laminate the additional polymerizable material to the object, thus adding a layer to the object attached to the build platform. The process of irradiating polymerizable material to add an additional object layer formed from polymerizable material to an object may be referred to herein as a “lamination.” Referring to step 265, if the object is the desired three-dimensional object or an intermediate having the same shape, or the shape to be imparted to, the three-dimensional object, then the object or intermediate formation process may end (see step 266). However, if the object or intermediate is not the desired three-dimensional object or intermediate, then process steps 255 and 260 will repeat until the desired three-dimensional object or intermediate, is formed. In such methods, the optically transparent film (i) includes light scattering particles therein and/or thereon; and/or (ii) has an optical profile that varies along the length, and optionally the width, of the film.

While the film transport assembly 135 is depicted as a roller apparatus, other types of film transport assemblies 135 may be used. In addition, other variations of the non-optional elements are envisioned. For example, the coating applicator 120 may be integrally associated with the film transport assembly 135. As another example, there may be multiple controllers and/or drive assemblies 170, which may each be operatively associated with one or more of the elements of the apparatus 100.

Referring again to FIG. 1, in some embodiments, RFP methods may be performed such that the film transport assembly 135 conveys the optically transparent film 130 to the desired position and the build platform 115 only moves in the vertical (or Z) direction, so that the build platform contacts the polymerizable material 125 in a “stamping” motion (referred to herein as “stamping RFP methods”). However, in other embodiments, in addition to moving in the vertical direction, the build platform may also move in the horizontal (or X-Y) direction, optionally wherein the build platform or object contacts the polymerizable material (e.g., in step 245 or 255 in FIG. 2) and/or the polymerizable material is irradiated (e.g., in step 250 or 260 in FIG. 2) while the build platform, and optionally the optically transparent film, are moving (e.g., in a horizontal motion). Such RFP methods may be referred to herein as “translational platform RFP methods.” For example, as the polymerizable material 125 on the film 130 moves over the radiation source 105, build platform 110 may also move in the same direction (e.g., at roughly the same rate) while lowering to contact the polymerizable material 125. Then, after lamination, the build platform 110 may raise up and reposition to repeat the process. Both stamping and translational platform RFP processes are envisioned to be used with the methods and apparatus of the present invention.

### Polymerizable Material

Polymerizable materials (also referred to herein as resins) that may be used in the present methods and apparatus are known and described in, for example, DeSimone et al., U.S. Pat. Nos. 9,211,678; 9,205,601; and 9,216,546. Dual cure resins for additive manufacturing are known and described in, for example, Rolland et al., U.S. Pat. Nos. 9,676,963; 9,598,606; and 9,453,142. Non-limiting examples of dual cure resins include, but are not limited to, resins that include precursors to polymers such as polyurethane, polyurea, and copolymers thereof; epoxies; cyanate esters; silicone, etc. Any suitable resin may be used in the methods described herein, including single cure, dual cure, elastomer-forming resins, and thermoset-forming resins.

The polymer resins typically include at least one UV reactive monomer or prepolymer and at least one photoinitiator. Further, additional optional additives, including but not limited to, reactive diluents, heat and/or moisture-curable monomers or prepolymers, crosslinkers, non-reactive diluents, UV absorbers, pigments, dyes, antioxidants, plasticizers, fillers, radical inhibitors, heat expandable microspheres, and thermal inhibitors, may also be present in the polymerizable liquid.

In some embodiments, the polymerizable material may be a viscous or highly viscous liquid (e.g., having a viscosity in a range of 5,000 centipoise (cP) to 100,000 cP, 500,000 cP, 1 McP, or greater). In some embodiments, the polymerizable material may be a paste or plastic fluid, or other materials that do not flow until a critical stress is achieved. In particular embodiments, the viscous material comprises a silicone.

### Optically Transparent Film

The polymerizable material is coated on (dispensed or otherwise applied to) an optically transparent film. The optically transparent film is a polymer film that is transparent to actinic radiation or light at wavelengths used to cure the polymerizable material (e.g., emitted by one or more radiation source used herein), although some of such actinic radiation or light may be scattered. In some embodiments, the optically transparent film is permeable to a polymerization inhibitor (e.g., an oxygen inhibitor). Examples include fluorinated ethylene propylene film, cyclic olefin polymers, polyethylene. including ultra-high molecular weight polyethylene, thin flexible ceramics like willow glass or sapphire films; Silicone base films can coated films (e.g. PDMS).

The polymerizable material may be applied to the optically transparent film by a number of possible methods, including, e.g., rollers (e.g., and application and/or metering rollers), dispensers, sprayers, blades, baths, and any combination thereof.

In some embodiments of the invention, the optically transparent film includes light scattering particles therein and/or thereon. Many types of scattering particles may be used. However, in some embodiments, the scattering particles include transparent to semi-transparent microspheres including but not limited to aluminosilicates, borosilicates, polystyrene, polyethylene, polymethyl methacrylate, barium titanate, and/or polypropylene. In some embodiments, the scattering particles have a diameter (or longest width) in a range of 1 𝜇m to 100 𝜇m (e.g., 1 𝜇m, 2 𝜇m, 5 𝜇m, 10𝜇m, 12 𝜇m, 15𝜇m, 20 𝜇m, 25𝜇m, 30𝜇m, 40𝜇m, 50𝜇m, 60𝜇m, 70𝜇m, 80𝜇m, 90𝜇m, 100 𝜇m, or any range defined any two of the foregoing values), In particular embodiments, the scattering parties have a size in a range of 2 𝜇m to 12 𝜇m. While in some embodiments, the particles are spherical, other shapes including ovoid or irregular may be used. In some embodiments, the scattering particles are dispersed within the film, for example, at a concentration in a range of 1 wt % to 50 wt% (e.g, 2%, 5%, 10%, 15%, 20%, 25%, 30%, 35%, 40%, 45%, 50%, or any range defined between any two of the foregoing values). In some embodiments, the scattering particles are coated onto one or more surfaces of the optically transparent film. In some embodiments, the scattering particles are liquid crystals (e.g., nematic and/or cholesteric liquid crystals). In some embodiments, the type, size, and/or dispersion of scattering particles in and/or on the film may vary along the length and/or width of the film.

The optically transparent film may have an optical profile that varies along the length, and optionally the width, of the film. In some embodiments, the optical profile may vary along the length, and optionally the width, of the film, due to the presence (e.g., variation in amount) of scattering particles in and/or on the film, but variations in optical profile may be achieved by other means. For example, the film may be roughened, or the polymer composition may vary, along the length of the film.

As used herein, the term “optical profile” refers to the manner in which the film interacts with light due to, for example, surface roughness or texture, or due to additives (e.g., particles) in and/or on the film that interact with light. An optical profile is different or varies from another optical profile if it varies significantly (e.g., by 5%, 10%, or more). As such, the difference in optical profile is not due to normal variations found within a material but due to changing the roughness or topology of the film, or by varying composition and/or additives in and/or on the film.

In some embodiments, an optical parameter that varies along the length of the film is the amount of scattering and/or the transmittance %. For example, in some embodiments, the transmittance of a film may vary in a range of 40% to 95% (e.g., 40%, 50%, 60%, 70%, 80%, 90%, 95%, or any range defined between any two of the foregoing values). In some embodiments, the transmittance of at least one portion of the film has a transmittance that is different (e.g., 10%, 20%, 30%, or more) than the transmittance of at least one other portion of film used to make the three-dimensional object. In some embodiments, the transmittance of the film is varied by varying the amount of scattering particles in the film.

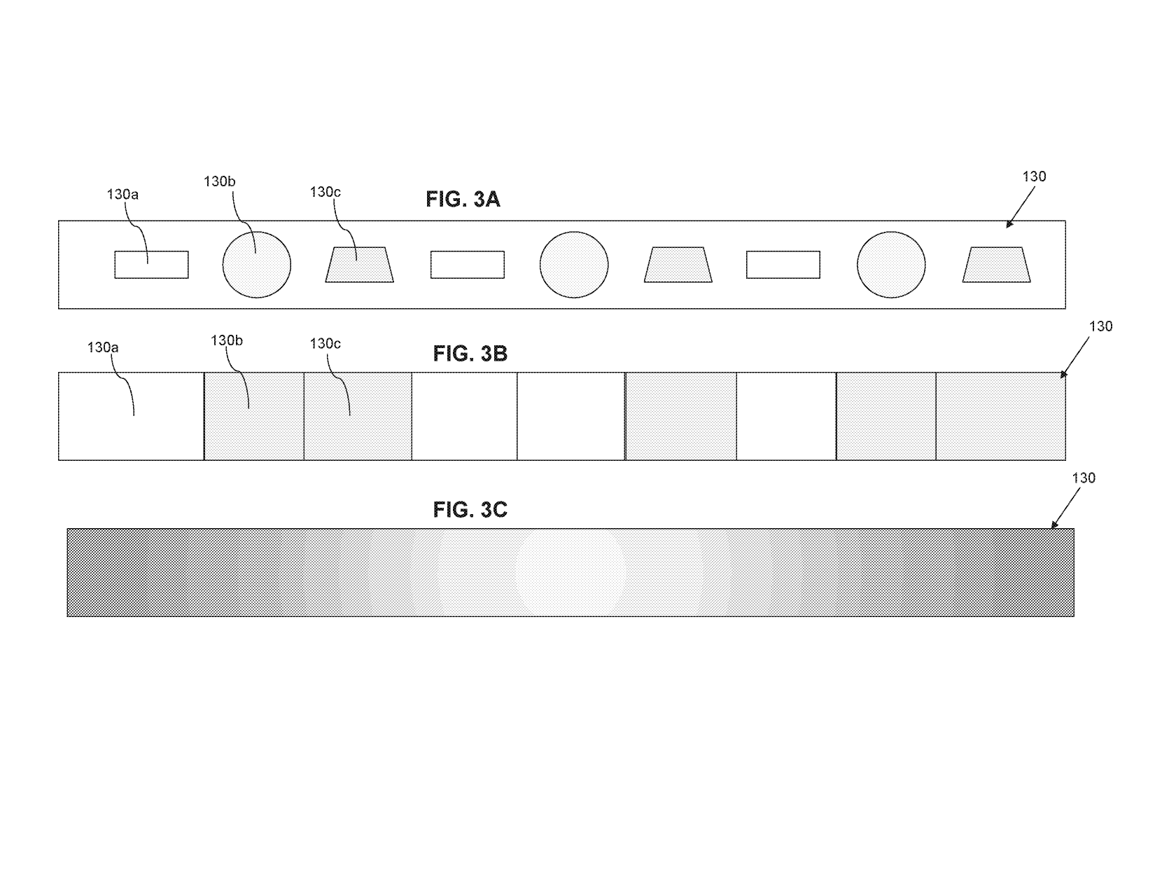

Referring to FIGS. 3A-3C, the variation in the optical profile (e.g., transmittance %) along the length of film may take a number of possible forms. For example, referring to FIG. 3A, in some embodiments, the optically transparent film may include discrete regions 130a, 130b, 130c, for example, discrete regions corresponding to shapes corresponding to portions of an object or object layer (not shown) formed during a RFP method step (e.g., step 250 or step 260 in FIG. 2). As such, the discrete regions may correspond to regions of the film that will be irradiated to form an object or object portion. Such discrete regions 130a, 130b, 130c may have optical profiles that vary from other portions of the optically transparent film 130 and/or each discrete region 130a, 130b or 130c may have the same or a different optical profile as the other discrete regions. In some embodiments, such discrete regions 130a, 130b, 130c are formed by coating scattering particles (or compositions including the same) in the regions. In some embodiments, such discrete regions 130a, 130b, 130c are formed by roughing or texturizing the film in the regions.

Referring to FIG. 3B, in some embodiments, the discrete regions 130a, 130b, 130c are not directed to particular shapes correlated with an object layer (not shown) but are more general blocks having different optical profiles. For example, such discrete regions 130a, 130b, 130c could be positioned such that each layer in the three-dimensional object is formed using a portion of optically transparent film 130 having a particular optical profile, wherein certain layers could have different optical profiles and certain layers could have the same optical profile (or each layer may have a unique optical profile).

Referring to FIG. 3C, in some embodiments, the optically transparent film 130 does not have discrete portions having different optical profiles, but instead, the optical profile of the film 130 may vary in a continuous fashion.

### Radiation Source

A number of suitable radiation sources may be used in embodiments of the invention. In some embodiments, the radiation source is an actinic radiation source, such as one or more light sources, and in particular one or more ultraviolet light sources. Any suitable light source can be used, such as incandescent lights, fluorescent lights, phosphorescent or luminescent lights, a laser, light-emitting diode, etc., including arrays thereof. The radiation source may include a pattern-forming element operatively associated with the controller.

In some embodiments, the irradiation is carried out with patterned irradiation. The patterned irradiation may be a fixed pattern or may be a variable pattern created by a pattern generator (e.g., a DLP, LCD, etc.) as discussed below, depending upon the particular item being fabricated. In particular embodiments, the light source or pattern forming element comprises a digital (or deformable) micromirror device (DMD) with digital light processing (DLP), a spatial modulator (SLM), or a microelectromechanical system (MEMS) mirror array, a mask (aka a reticle), a silhouette, or a combination thereof.

### Build Platform

The build platform is the surface, typically planar, on which the three-dimensional object is formed. The build platform is operatively connected to a controller and/or drive assembly that may translate the build platform in the vertical (Z direction), and optionally, horizontal (X and Y) direction.

### Controller

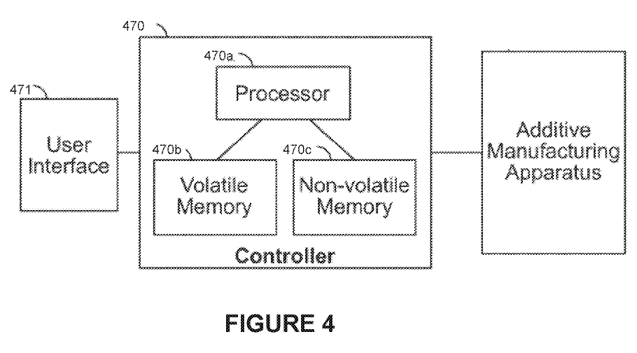

Referring to FIG. 4, controller 470 may be of any suitable type, such as a general-purpose computer. Typically, the controller 470 will include at least one processor 470a, a volatile (or “working”) memory 470b, such as random-access memory, and at least one non-volatile or persistent memory 470c, such as a hard drive or a flash drive. The controller 470 may use hardware, software implemented with hardware, firmware, tangible computer-readable storage media having instructions stored thereon, and/or a combination thereof, and may be implemented in one or more computer systems or other processing systems. The controller 470 may also utilize a virtual instance of a computer. As such, the devices and methods described herein may be embodied in any combination of hardware and software that may all generally be referred to herein as a “circuit,” “module,” “component,” and/or “system.” Furthermore, aspects of the present invention may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

The at least one processor 470a of the controller 470 may be configured to execute computer program code for carrying out operations for aspects of the present invention, which computer program code may be written in any combination of one or more programming languages, including an object oriented programming language such as Java, Scala, Smalltalk, Eiffel, JADE, Emerald, C++, C#, VB.NET, or the like, conventional procedural programming languages, such as the “C” programming language, Visual Basic, Fortran 2003, COBOL 2002, PHP, ABAP, dynamic programming languages such as Python, PERL, Ruby, and Groovy, or other programming languages.

The at least one processor 470a may be, or may include, one or more programmable general purpose or special-purpose microprocessors, digital signal processors (DSPs), programmable controllers, application specific integrated circuits (ASICs), programmable logic devices (PLDs), field-programmable gate arrays (FPGAs), trusted platform modules (TPMs), or a combination of such or similar devices, which may be collocated or distributed across one or more data networks.

Connections between internal components of the controller 470 are shown only in part and connections between internal components of the controller 470 and external components are not shown for clarity, but are provided by additional components known in the art, such as busses, input/output boards, communication adapters, network adapters, etc. The connections between the internal components of the controller 470, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, an Advanced Technology Attachment (ATA) bus, a Serial ATA (SATA) bus, and/or an Institute of Electrical and Electronics Engineers (IEEE) standard 1394 bus, also called “Firewire.”

The controller 470 may be associated with a user interface 471. The user interface 471 may be of any suitable type. The user interface 471 may include a display and/or one or more user input devices. The display may be accessible to the at least one processor 470a a via the connections between the system components. The display may provide graphical user interfaces for receiving input, displaying intermediate operation/data, and/or exporting output of the methods described herein. The display may include, but is not limited to, a monitor, a touch screen device, etc., including combinations thereof. The input device may include, but is not limited to, a mouse, keyboard, camera, etc., including combinations thereof. The input device may be accessible to the at least one processor 470a via the connections between the system components. The user interface 471 may interface with and/or be operated by computer readable software code instructions resident in the volatile memory 470b that are executed by the processor 470a.

In some embodiments, the first and/or second drive assemblies may be consolidated together as an XYZ drive, or some may be existing drive components of a CNC machine, to which an “applicator assembly” comprised of the supply chamber(s), rollers, blades, optionally additional drive components, light source, or at least rollers, all on a corresponding mounting frame, may be mounted or retrofitted. Examples of suitable CNC machines include, but are not limited to, the HAAS VF-2, VF-4, and VF-12/40 vertical CNC machines, and the HAAS EC-400 and EC-400 horizontal CNC machines, available from Haas Automation, Inc., 2800 Sturgis Road, Oxnard, Calif., 93030 U.S.A.

### Optional Additional Methods

In some embodiments, the methods further include the steps of (prior to additive manufacturing), (i) providing digital model(s) of at least one object; (ii) determining a desired configuration of the object(s) on the build platform (e.g., a configuration determined by a computer processor as providing an optimal orientation based on factors including maximum parts per build, minimal resin use, and the like); (iii) creating a digital model of the object(s) in the desired configuration; (iv) processing the digital model in step (iii) to form processed data for use by the additive manufacturing apparatus; and transmitting the processed data to the additive manufacturing apparatus, followed by manufacturing the object(s) by a methods and/or apparatus described herein.

In some embodiments, the three-dimensional object or intermediate formed by a method and/or apparatus of the invention may be further processed. For example, if a dual cure resin was used as in the polymerizable material, the dual cure resin may be further cured (e.g., by applying heat and/or contacting with moisture). In addition, the three-dimensional object or intermediate may be cleaned to remove excess resin.

Any type of object may be fabricated according to embodiments of the invention. Accordingly, provided according to embodiments of the invention are objects formed by a method and/or apparatus described herein. In addition, provided is an object that includes at least one layer or slice formed using an optically transparent film having scattering particles therein and/or thereon. In addition, provided is an object that is formed using an optically transparent film having two or more different optical profiles. In some embodiments, the object formed by a method and/or apparatus of the invention includes two or more different finishes (due to the use of the two or more different optical profiles). For example, the object may have regions that have different levels of clarity, gloss, or matte. In some embodiments, the objects of the invention are dental appliances (e.g., prosthetic denture bases, partial dentures, and teeth such as inlays, onlays, veneers, long term provisionals), footwear portions (e.g., insoles or outsoles), or saddles.

The foregoing is illustrative of the present invention and is not to be construed as limiting thereof. The invention is defined by the following claims, with equivalents of the claims to be included therein.

What is claimed is:

1. A method of making a three-dimensional object, comprising:
(a) coating polymerizable material onto an optically transparent film;
(b) positioning a first portion of the film having polymerizable material thereon between a radiation source and a build platform such that the polymerizable material contacts the build platform;
(c) irradiating the polymerizable material through the first portion of the film with the radiation source to solidify and laminate the polymerizable material onto the build platform, thereby forming an object attached to the build platform;
(d) positioning an additional portion of the film having additional polymerizable material thereon between the radiation source and the build platform such that the additional polymerizable material contacts the object;
(e) irradiating the additional polymerizable material through the additional portion of the film with the radiation source to solidify and laminate the additional polymerizable material onto the object, thereby adding a layer to the object;
(f) repeating steps (d) and (e) until the object attached to the build platform forms the three-dimensional object or an intermediate having the same shape, or the shape to be imparted to, the three-dimensional object, wherein:
(i) each portion of the optically transparent film has an optical profile and at least one portion of the film that is irradiated in step (c) or step (e) has a different optical profile from at least one other portion of the film irradiated in step (c) or step (e); and/or
(ii) the optically transparent film comprises scattering particles dispersed therein.

2. The method of claim 1, wherein the optical profile of the optically transparent film varies along the length, and optionally the width, of the film.

3. The method of claim 1, wherein the transmittance of at least one portion of the film that is irradiated in step (c) or step (e) is different than the transmittance of the at least one other portion of film irradiated in step (c) or step (e).

4. The method of claim 1, wherein the optical profile of the film is varied by varying the amount of scattering particles in the film.

5. The method of claim 4, wherein the scattering particles comprise one or more of transparent to semi-transparent microspheres.

6. The method of claim 5, wherein the scattering particles have a diameter or longest width in a range of 1 𝜇m to 100 𝜇m.

7. The method of claim 5, wherein the scattering particles are present in the film at a concentration in a range of 2 weight percent to 50 weight percent.

8. The method of claim 1, wherein the intermediate having the same shape, or the shape to be imparted to, the three-dimensional object is formed, and the method further includes further curing the intermediate to form the three-dimensional object.

9. The method of claim 8, wherein further curing comprises heating, microwave irradiation, and/or contacting the intermediate with water.

10. The method of claim 1, wherein during irradiation, a dead zone of unpolymerized material is present between (i) the polymerizable material and the first portion of optically transparent film and (ii) the additional polymerizable material and the additional portion of portion of the optically transparent film.

11. An apparatus for forming a three-dimensional object, comprising
(a) at least one radiation source;
(b) a build platform on which a three-dimensional object is formed;
(c) an optically transparent film and a film transport assembly for moving the optically transparent film between the at least one radiation source and the build platform;
(d) an applicator for coating polymerizable material onto the optically transparent film;
(e) at least one controller and/or drive assembly; and
(f) optionally a housing and/or frame,
wherein the optically transparent film (i) comprises light scattering particles therein and/or thereon; and/or (ii) has an optical profile that varies along the length, and optionally the width, of the film.

12. The apparatus of claim 11, wherein the optical profile of the film varies along the length, and optionally the width, of the film.

13. The apparatus of claim 11, wherein the optical profile of the film varies by varying the amount of scattering particles in the film.

14. The apparatus of claim 13, wherein the scattering particles comprise one or more of transparent to semi-transparent microspheres.

15. The apparatus of claim 14, wherein the scattering particles have a diameter or longest width in a range of 1 𝜇m to 100 𝜇m.

16. The apparatus of claim 14, wherein the scattering particles are present in the film at a concentration in a range of 2 weight percent to 50 weight percent.
